(19) United States
(12) Patent Application Publication
(10) Pub. No.: US 2025/0374901 A1
(43) Pub. Date: Dec. 11, 2025

(54) LURE

(71) Applicant: Shimano Inc., Osaka (JP)

(72) Inventors: Kazuto NAKAMURA, Osaka (JP); Naoki SHIMODA, Osaka (JP); Yoshiyuki TAKEMOTO, Osaka (JP); Takumi KUWABARA, Osaka (JP)

(21) Appl. No.: 19/209,496

(22) Filed: May 15, 2025

(30) Foreign Application Priority Data
Jun. 6, 2024 (JP) 2024-092188

(51) Int. Cl. A01K 85/16; A01K 85/00

(52) U.S. Cl. CPC A01K 85/16; A01K 85/1837

(57) ABSTRACT

A lure comprises a body. The body is configured to have an internal space inside an outer shell. The body has, in the internal space, an array structure in which grid lines are arranged in a generally uniform manner.

### CROSS-REFERENCE TO RELATED APPLICATIONS

This application claims priority to Japanese Patent Application No. 2024-092188, filed on Jun. 6, 2024. The entire disclosure of Japanese Patent Application No. 2024-092188 are hereby incorporated by reference.

### BACKGROUND

### Technical Field

The present disclosure relates to a lure.

### Background Information

Japanese Laid Open Patent Application No. Hei 11 (1999)-48285 discloses a lure having a body made of a foamed resin material.

### SUMMARY

Lures preferably move in water so as to attract target organisms for capture that pray on small fish, and the like. For this reason, in some conventional lures the weight and the center of gravity of the lure can be adjusted. For example, the weight and the center of gravity of these lure are adjusted using weights.

However, even if weights are used to adjust the weight and the center of gravity of the lure, it has been determined that there is still room for further improvement in the lure so that the movement of the lure in the water is a movement that more favorably attracts target organisms for capture.

One object of the present disclosure is to provide a lure having movement in water that is improved.

A lure according to a first aspect of the present disclosure comprises a body. The body is configured to have an internal space inside an outer shell. The body has, in the internal space, an array structure in which grid lines are arranged in a generally uniform manner.

According to the lure of the first aspect, the array structure provided in the internal space of the body can be adjusted to change the weight, center of gravity, center of buoyancy, and moment of inertia of the lure. As a result, the lure can be set to a favorable weight, buoyancy, center of gravity, center of buoyancy, and moment of inertia, thereby improving the movement in water. Accordingly, the lure can suitably attract target organisms for capture. As a result of the array structure being changed, the weight, buoyancy, center of gravity, center of buoyancy, and moment of inertia of the lure can be changed without, for example, changing the outer shape of the lure. Therefore, the manufacturer of the lure can provide lures that have the same shape but move differently in water. The lure's array structure can support the outer shell from the inside. Therefore, the strength of the body of the lure having an internal space can be improved.

In a lure of a second aspect according to the first aspect, the array structure has grid lines arranged three-dimensionally.

According to the lure of the second aspect, for example, the center of gravity, center of buoyancy, and moment of inertia of the lure can be changed in the front-rear direction, the left-right direction, and the up-down direction of the lure. As a result, the center of gravity, center of buoyancy, and moment of inertia of the lure can each be set to a favorable position thereby improving the movement of the lure in water. As can be understood, the strength of the body of the lure can be improved in all directions of the lure.

In a lure of a third aspect according to the first or second aspects, the array structure includes a first array structure and a second array structure. The first array structure has a first pitch. The second array structure has a second pitch that is different from the first pitch.

According to the lure of the third aspect, the weight, center of gravity, center of buoyancy, and moment of inertia of the lure can be changed by the first and second array structures having different pitches. As a result, the lure can be set to a favorable weight, buoyancy, center of gravity, center of buoyancy, and moment of inertia, thereby improving the movement of the lure in water.

In a lure of a fourth aspect according to the third aspect, the first and second array structures are provided in the internal space in accordance with a buoyant force arrangement in the lure.

According to the lure of the fourth aspect, the arrangement of the first and second array structures in the internal space can be adjusted to realize a favorable buoyant force arrangement of the lure. As a result, the movement of the lure in water is improved.

In a lure of a fifth aspect according to the third or fourth aspects, the internal space includes a first space and a second space. The distance between inner walls is greater in the second space than between inner walls in the first space. The second pitch is smaller than the first pitch. The first array structure is provided in the first space. The second array structure is provided in the second space.

According to the lure of the fifth aspect, the inner walls of the outer shell in which the distance between the inner walls is large can be supported by the second array structure. Therefore, the strength of the outer shell of the lure in which the distance between the inner walls is large can be improved.

In a lure of a sixth aspect according to any one of the first to the fifth aspects, the outer shell and the array structure are integrally formed from metal or resin.

According to the lure of the sixth aspect, the array structure that is formed integrally with the outer shell is able to support the outer shell. Therefore, the strength of the body of the lure can be improved.

In a lure of a seventh aspect according to any one of the first to the sixth aspects, the body has a first body and a second body. The first body has a first outer shell. The second body has a second outer shell, and is joined to the first body, forming an internal space.

According to the lure of the seventh aspect, the first and second bodies are joined, thereby making it possible to dispose an array structure in the internal space. For example, in the case that the material used in forming the first and second bodies remains in the first and second bodies after forming, the lure is able to easily discharge the material remaining in the first and second bodies.

In an eighth aspect according to the sixth or seventh aspects, the body is formed with a 3D printer.

According to the lure of the eighth aspect, the body can be easily manufactured with a 3D printer. Therefore, an array structure with a complex shape in the internal space of the body can be formed.

In a lure of a ninth aspect according to any one of the first to the eighth aspects, the lure comprises a first eye. The first eye is configured such that a fishing line is connected thereto. A portion of the first eye is embedded in the body.

According to the lure of the ninth aspect, it is possible to prevent the first eye from falling off from the body. For example, the body of the lure can be formed around the first eye with a 3D printer, thereby integrating a portion of the first eye and the body.

In a lure of a tenth aspect according to any one of the first to the ninth aspects, the lure comprises a second eye. The second eye is configured such that a hook portion can be connected thereto. A portion of the second eye is embedded in the body.

According to the lure of the tenth aspect, it is possible to prevent the second eye from falling off from the body. For example, the body of the lure can be formed around the second eye with a 3D printer, thereby integrating a portion of the second eye and the body.

According to the lure of the present disclosure, it is possible to improve the movement in water.

### BRIEF DESCRIPTION OF THE DRAWINGS

FIG. 1 is a left side view of a spinning reel.

FIG. 1 is a side view of a lure according to a first embodiment.

FIG. 2 is a plan view of a lure according to the first embodiment.

FIG. 3 is a cross-sectional view through line III-III in FIG. 2.

FIG. 4 is a diagram showing the body in FIG. 3.

FIG. 5 is a perspective view of the V-V cross section of FIG. 1.

FIG. 6 is a flowchart explaining a manufacturing method of the lure according to the first embodiment.

FIG. 7 is a diagram explaining a first space in a lure according to a second embodiment.

FIG. 8 is a diagram explaining a second space in the lure according to the second embodiment.

FIG. 9 is a diagram explaining a first array structure in the lure according to the second embodiment.

FIG. 10 is a diagram explaining a second array structure in the lure according to the second embodiment.

FIG. 11 is a plan view of a lure according to a third embodiment.

### DETAILED DESCRIPTION

### Embodiment 1

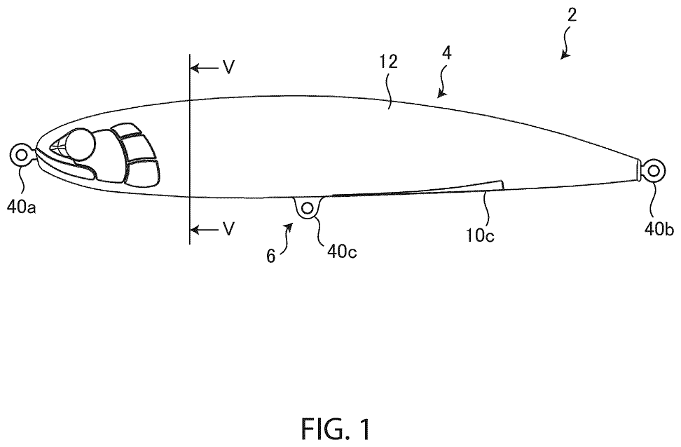

A lure 2 according to the first embodiment will be described with reference to FIGS. 1-4. The lure 2 is, for example, a lure for capturing large fish (fish eaters) that prey on small fish. Examples of large fish include largemouth bass, yellowtail, juvenile yellowtail, and sea bass. The lure 2 has a shape resembling a small fish.

In this Specification, terms indicating the directions “front,” “rear,” “forward (front side),” “rearward (rear side),” “left,” “right,” “leftward,” “rightward,” “up,” “down,” “upward,” “downward,” as well as any other similar direction, are defined as follows.

“Front” and “forward (front side)” indicate the direction of travel in which the lure 2 travels while being pulled by a fishing line to which the lure 2 is connected. “Rear” and “rearward (rear side)” are directions opposite to the direction of travel. “Front-rear direction” corresponds to the longitudinal direction of the lure 2.

“Up” and “upward” indicate the direction toward the surface of the water when the lure 2 is moving forward in the water. “Down” and “downward” indicate the direction toward the bottom of the water when the lure 2 is moving forward in the water. “Left,” “leftward,” “right,” and “rightward” are defined based on “up” and “down”.

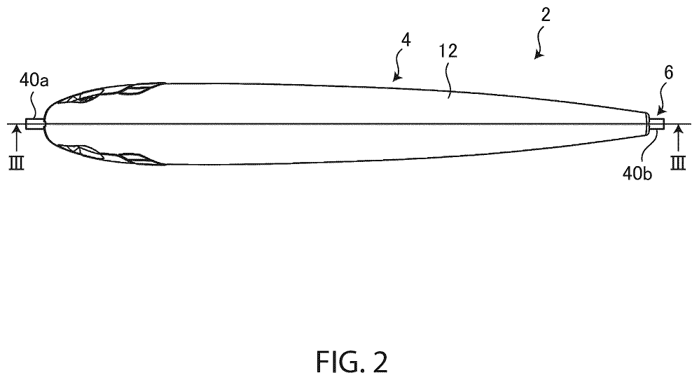

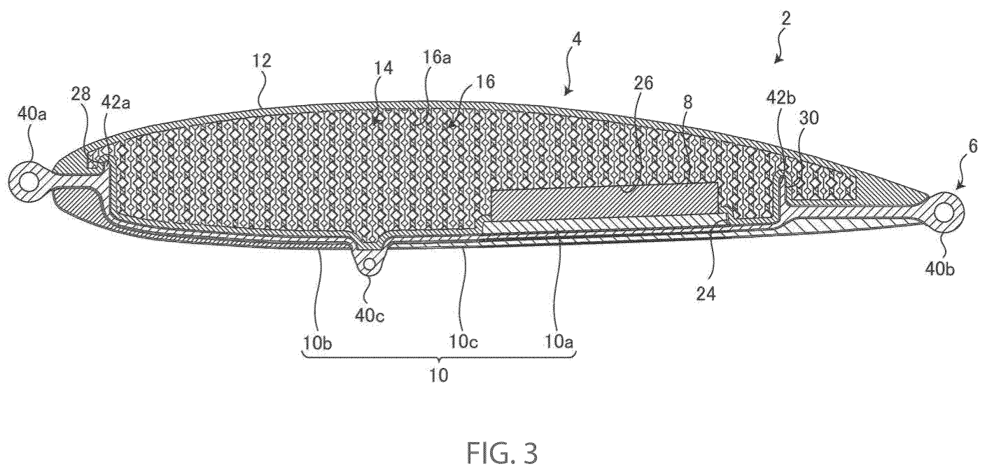

As shown in FIGS. 1 and 2, the lure 2 comprises a body 4 and a wire 6. As shown in FIG. 3, the lure 2 comprises a weight part 8 and a plurality of covers 10.

As shown in FIGS. 1-4, the body 4 is formed extending in the front-rear direction. The body 4 includes an outer shell 12. The outer shell 12 constitutes the outer shape of the lure 2. The outer shell 12 is configured to resemble the shape of a small fish. As shown in FIGS. 3-5, the body 4 has an internal space 14 inside the outer shell 12. The body 4 has an array structure 16. The outer shell 12 and the array structure 16 are integrally formed from resin or metal. The surface of the body 4 may be decorated by painting, printing, application of fabric, or the like.

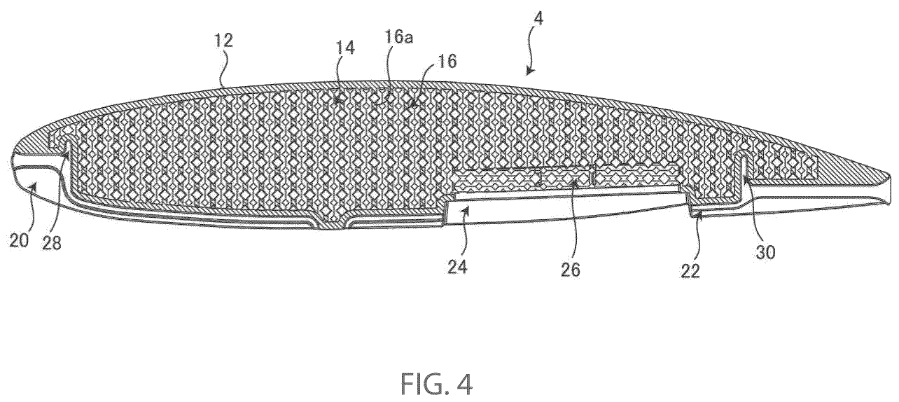

The array structure 16 is provided in the internal space 14. The array structure 16 is provided in a portion of the internal space 14. The array structure 16 is provided in the entire internal space 14 excluding a location where a second recess 26 (refer to FIG. 4) is provided, described further below. In the case that the second recess 26 is not provided, the array structure 16 can be provided in the entire internal space 14. The array structure 16 is formed of grid lines 16a arranged in a generally uniform or consistent manner. In the array structure 16, the grid lines 16a are arranged three-dimensionally. For example, the grid lines 16a are arranged so as to form the edges of a polyhedron. A plurality of polyhedral spaces are periodically and generally uniformly formed in the internal space 14. The grid lines 16a can form spaces of a plurality of types of polyhedrons. The array structure 16 is provided in accordance with the buoyant force arrangement of the lure 2. The buoyant force arrangement is the balance of the buoyant force that causes the movement of the lure 2 in water to become a movement aligned with the design intent. The buoyant force arrangement includes, for example, the weight and buoyancy of the lure 2. The buoyant force arrangement includes the center of gravity and the center of buoyancy of the lure 2.

As shown in FIG. 4, a first groove portion 20, a second groove portion 22, a first recess 24, the second recess 26, a third recess 28, and a fourth recess 30 are formed in the body 4. The first groove portion 20 is formed so as to be recessed upward from the lower end of the body 4. The first groove portion 20 is formed so as to extend rearward from the front end of the body 4. The first groove portion 20 is provided outside of the internal space 14. The first groove portion 20 does not communicate with the internal space 14.

The second groove portion 22 is formed so as to be recessed upward from the lower end of the body 4. The second groove portion 22 is formed so as to extend forward from the rear end of the body 4. The second groove portion 22 is provided rearward of the first groove portion 20. The second groove portion 22 is provided outside of the internal space 14. The second groove portion 22 communicates with the internal space 14 via the first recess 24 and the second recess 26.

The first recess 24 is formed so as to be recessed upward from the second groove portion 22. The first recess 24 is formed so as to extend rearward from the vicinity of the center of the body 4 in the front-rear direction.

The second recess 26 is formed so as to be recessed upward from the first recess 24. The length of the second recess 26 in the front-rear direction is shorter than the length of the first recess 24 in the front-rear direction. A portion of the second recess 26 is provided in the internal space 14.

The third recess 28 is provided forward of the first recess 24. The third recess 28 is formed so as to be recessed upward from the first groove portion 20. The third recess 28 is provided outside of the internal space 14. The third recess 28 does not communicate with the internal space 14.

The fourth recess 30 is provided rearward of the first recess 24. The fourth recess 30 is formed so as to be recessed upward from the second groove portion 22. The fourth recess 30 is provided outside of the internal space 14. The fourth recess 30 does not communicate with the internal space 14.

As shown in FIG. 3, the weight part 8 is inserted into the second recess 26. The lure 2 can be configured without the weight part 8. When the lure 2 does not comprise the weight part 8, the second recess 26 need not be formed in the body 4.

The wire 6 has a first eye 40a. The wire 6 has second eyes 40b, 40c. The wire 6 has a first protruding portion 42a and a second protruding portion 42b. The wire 6 can be made of metal. For example, the wire 6 can be a plate-like member formed from metal. In one embodiment, the wire 6 can be formed from a wire material. The wire 6 is formed so as to extend in the front-rear direction. The wire 6 is disposed in the first groove portion 20 (refer to FIG. 4) and the second groove portion 22 (refer to FIG. 4).

Each of the eyes 40a-40c is provided such that at least a portion thereof is exposed from the body 4. The first eye 40a is provided on the front end side of the lure 2. The first eye 40a is configured such that a fishing line can be connected thereto.

The second eye 40b is configured such that a hook portion can be connected thereto. The second eye 40b is provided on the rear end side of the lure 2. The second eye 40c is configured such that a hook portion can be connected thereto. The second eye 40c is provided on the lower end side of the lure 2. The second eye 40c is provided between the first eye 40a and the second eye 40b.

The first protruding portion 42a is formed so as to protrude upward. The first protruding portion 42a is inserted into the third recess 28. For example, the first protruding portion 42a is press-fitted into the third recess 28.

The second protruding portion 42b is formed so as to protrude upward. The second protruding portion 42b is provided rearward of the first protruding portion 42a. The second protruding portion 42b is inserted into the fourth recess 30. For example, the second protruding portion 42b is press-fitted into the fourth recess 30.

A plurality of covers 10 including a first cover 10a, a second cover 10b, and a third cover 10c can be disposed to cover the recesses and/or the grooves. For example, in one embodiment, the first cover 10a is inserted into the first recess 24 so as to close the opening of the second recess 26. The first cover 10a is, for example, bonded to the body 4 by an adhesive. The first cover 10a can be press-fitted into the first recess 24. The first cover 10a can be welded to the body 4.

The second cover 10b is provided at the lower end of the body 4. The second cover 10b is provided in the first groove portion 20 so as to cover, from below, the wire 6 provided in the first groove portion 20. The second cover 10b can be for example, bonded to the body 4 by an adhesive. The second cover 10b can be welded to the body 4. The second cover 10b can be press-fitted into the first groove portion 20. The first groove portion 20 between the second cover 10b and the body 4 can be filled with a filling material. The filling material can be a material having waterproofing properties. In one embodiment, the filling material is a silicon resin, an epoxy resin, or the like.

The third cover 10c is provided at the lower end of the body 4. The third cover 10c can be provided in the second groove portion 22 so as to cover, from below, the wire 6 provided in the second groove portion 22. The third cover 10c can be, for example, bonded to the body 4 by an adhesive. The third cover 10c can be welded to the body 4. The third cover 10c can be press-fitted into the second groove portion 22. The second groove portion 22 between the second cover 10b and the body 4 can be filled with a filling material.

The second cover 10b and the third cover 10c need not be provided to the lure 2. When the second cover 10b and the third cover 10c are not provided, the first groove portion 20 and the second groove portion 22 are filled with a filling material.

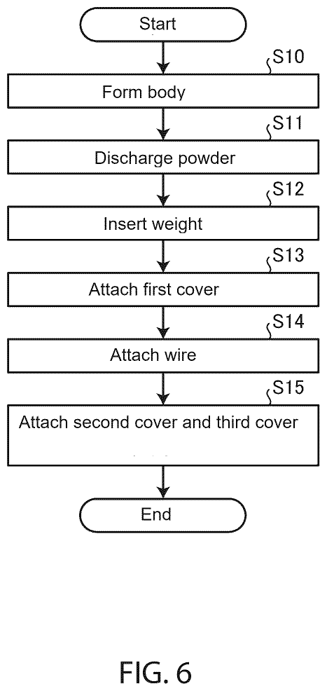

A method of manufacturing the lure 2 according to the first embodiment will be described with reference to the flowchart shown in FIG. 6.

In step S10, the body 4 is formed with a 3D printer. For example, the 3D printer method for forming the body 4 is a powder sintering method. The 3D printer method can also be, for example, fused deposition modeling (FDM) method, photolithography method, inkjet method, binder jetting method, or bound metal deposition (BMD) method.

Next, in step S11, of the powder used to form the body 4, the un-sintered powder remaining in the internal space 14 of the body 4 is discharged to the outside of the body 4 from the second recess 26, the first recess 24, and the second groove portion 22. Next, in step S12, the weight part 8 is inserted into the second recess 26. Next, in step S13, the first cover 10a is attached to the body 4.

Next, in step S14, the wire 6 is attached to the body 4. The wire 6 can be configured such that one of the first protruding portion 42a and the second protruding portion 42b is press-fitted into the corresponding third recess 28 or fourth recess 30. The wire 6 can be configured such that a portion of the wire 6 is press-fitted into the first groove portion 20 and/or the second groove portion 22.

Next, in step S15, the second cover 10b and the third cover 10c are attached to the body 4.

The body 4 can be integrally formed with the weight part 8 and the wire 6 using a 3D printer. For example, if the 3D printer method is the powder sintering method, the 3D printer forms the body 4 from a state in which the weight part 8 and the wire 6 are provided in powder. When the body 4 is integrally formed with the weight part 8 and the wire 6 by a 3D printer, the location corresponding to the covers 10 is formed by the body 4. As a result, for example, a portion of the first eye 40a is embedded in the body 4. A portion of the second eye 40b is embedded in the body 4.

### Embodiment 2

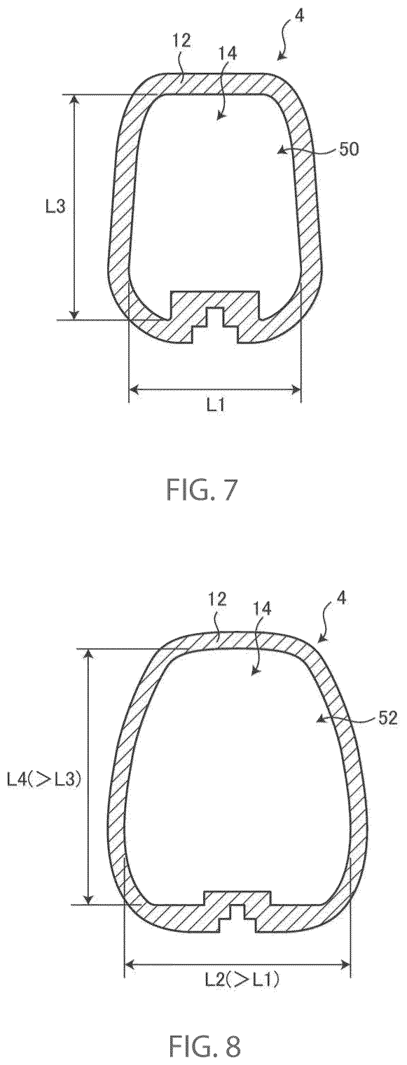

A lure 2 according to a second embodiment will be described with reference to FIGS. 7-10. Descriptions of configurations that are the same as those of the first embodiment will be omitted.

The internal space 14 of the body 4 includes a first space 50, as shown in FIG. 7. As shown in FIG. 8, the internal space 14 includes a second space 52. In FIGS. 7 and 8, the array structure 16 (refer to FIG. 3) is omitted for the purpose of explanation. The distance between the inner walls is greater in the second space 52 than in the first space 50. The distance L2 between the inner walls of the second space 52 in the left-right direction is greater than the distance L1 between the inner walls of the first space 50 in the left-right direction. The distance L4 between the inner walls of the second space 52 in the up-down direction is greater than the distance L3 between the inner walls of the first space 50 in the up-down direction. For example, the first space 50 is provided on the front side of the lure 2 and on the rear side of the lure 2. The second space 52 is provided on the center side of the lure 2 in the front-rear direction.

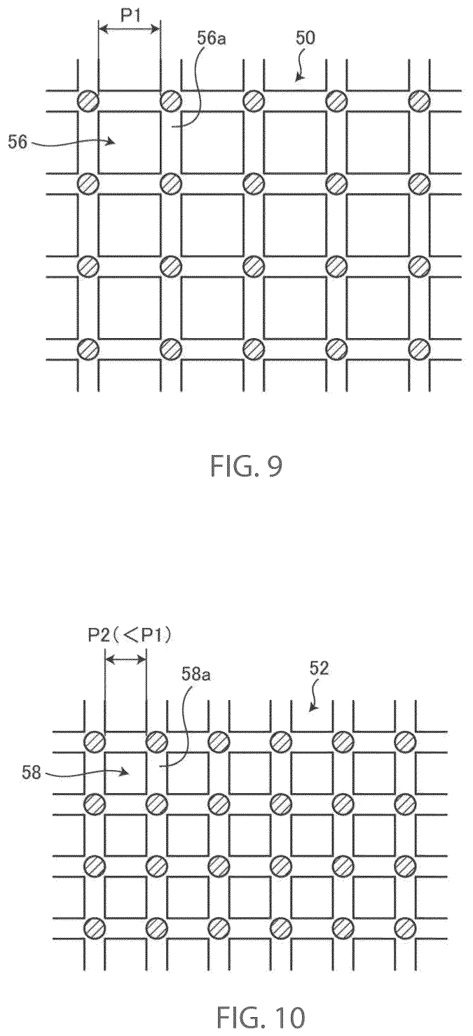

As shown in FIG. 9, the array structure 16 includes a first array structure 56. As shown in FIG. 10, the array structure 16 includes a second array structure 58.

The first array structure 56 is provided in the first space 50. The first array structure 56 has a first pitch. As shown in FIG. 9, the first pitch is the distance P1 between grid lines 56a in the first array structure 56. That is, the first pitch is the size of the space of the polyhedron formed by the first array structure 56. In FIG. 9, the first array structure 56 is shown in a simplified manner for the sake of explanation.

The second array structure 58 is provided in the second space 52. The second array structure 58 has a second pitch. The second pitch is different from the first pitch. The second pitch is smaller than the first pitch. As shown in FIG. 10, the second pitch is distance P2 between grid lines 58a in the second array structure 58. That is, the second pitch is the size of the space of the polyhedron formed by the second array structure 58. In FIG. 10, the second array structure 58 is shown in a simplified manner for the sake of explanation.

In the lure 2, when the distance between the inner walls in the internal space 14 of the body 4 is large, the pitch in the array structure 16 is small. The array structure 16 can include three or more array structures with different pitches. The array structure 16 can be provided such that the pitch varies gradually.

The first array structure 56 and the second array structure 58 can be provided in the internal space 14 in accordance with the buoyant force arrangement in the lure 2. For example, the first array structure 56 is provided in the internal space 14 at a location in the lure 2 where the weight is to be reduced. The second array structure 58 is provided in the internal space 14 at a location in the lure 2 where the weight is to be increased.

### Embodiment 3

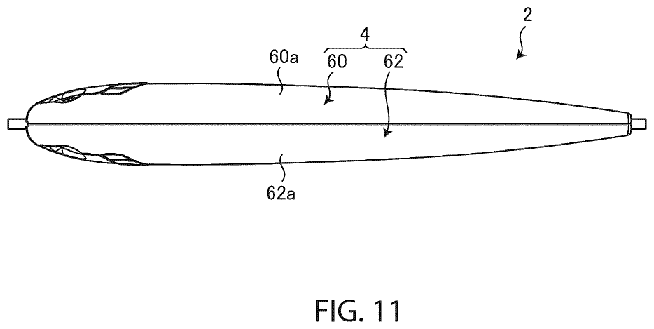

A lure 2 according to a third embodiment will be described with reference to FIG. 11. Descriptions of configurations that are the same as those of the first embodiment will be omitted.

The body 4 has a first body 60 and a second body 62. The body 4 is divided in the left-right direction by the first body 60 and the second body 62. The first body 60 and the second body 62 are joined to form the body 4.

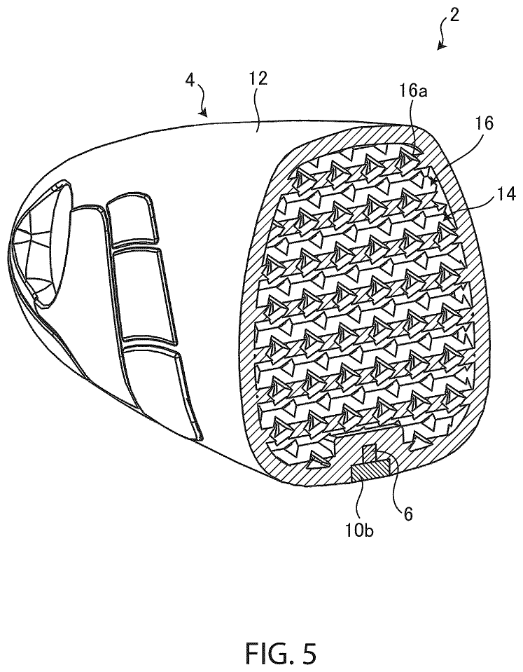

The first body 60 has a first outer shell 60a. The second body 62 has a second outer shell 62a. The second body 62 is joined to the first body 60, forming the internal space 14 (refer to FIG. 5). The first body 60 and the second body 62 each has the array structure 16. That is, the first body 60 and the second body 62 have the array structure 16 divided in the left-right direction (refer to FIG. 5). Alternatively, the array structure 16 can be formed in one of either the first body 60 or the second body 62.

The first body 60 and the second body 62 are joined to form the first groove portion 20 (FIG. 4) in the lure 2. That is, a configuration corresponding to the first groove portion 20, or the like, is formed in each of the first body 60 and the second body 62.

The lure 2 according to the third embodiment may be applied to the lure 2 according to the second embodiment. That is, in the lure 2 according to the second embodiment, the body 4 may be divided into the first body 60 and the second body 62.

As used in the present Specification, the phrase “at least one” means “one or more” of desired options. As an example, the phrase “at least one” as used in the present Specification means, if the number of options is two, “only one of the options” or “both of the two options.” As another example, the phrase “at least one” as used in the present Specification means, if the number of options is three or more, “only one of the options” or “any combination of two or more of the options.”

What is claimed is:

1. A lure, comprising
a body configured to have an internal space inside an outer shell, and
the body has, in the internal space, an array structure in which grid lines are arranged in a generally uniform manner.

2. The lure according to claim 1, wherein
the array structure has the grid lines arranged three-dimensionally.

3. The lure according to claim 1, wherein
the array structure includes
a first array structure having a first pitch, and
a second array structure having a second pitch different from the first pitch.

4. The lure according to claim 3, wherein
the first array structure and the second array structure are provided in the internal space in accordance with a buoyant force arrangement in the lure.

5. The lure according to claim 3, wherein
the internal space includes
a first space having inner walls, and
a second space having inner walls, the a distance between the inner walls of the second space being greater than a distance between the inner walls of the first space,
the second pitch is smaller than the first pitch,
the first array structure is provided in the first space, and the second array structure is provided in the second space.

6. The lure according to claim 1, wherein
the outer shell and the array structure are integrally formed from resin or metal.

7. The lure according to claim 1, wherein
the body includes
a first body having a first outer shell, and
a second body having second outer shell joined to the first body, to form an internal space.

8. The lure according to claim 6, wherein the body is formed by a 3D printer.

9. The lure according to claim 1, further comprising
a first eye configured to have a fishing line connected thereto, and
a portion of the first eye embedded in the body.

10. The lure according to claim 1, further comprising
a second eye configured to have a hook portion connected thereto, and
a portion of the second eye embedded in the body.
